(19) United States
(12) Patent Application Publication
(10) Pub. No.: US 2011/0244434 A1
(43) Pub. Date: Oct. 6, 2011

(54) System and Method of Analyzing Freeform Mathematical Responses

(75) Inventors: Nava L. Livne, Chicago, IL (US); Oren E. Livne, Chicago, IL (US); Charles A. Wight, Salt Lake City, UT (US)

(73) Assignee: University of Utah Research Foundation, Salt Lake City, UT (US)

(21) Appl. No.: 12/223,243

(22) PCT Filed: Jan. 29, 2007
(86) PCT No.: PCT/US2007/002388

§ 371 Date: Jun. 14, 2011

Related U.S. Application Data
(60) Provisional application No. 60/763,067, filed on Jan. 27, 2006.

(51) Int. Cl. G09B 19/02

(52) U.S. Cl. 434/188

(57) ABSTRACT

A system and method are provided of analyzing a response expression in a freeform format as entered by a student in response to testing and practice questions presented by a computer system. The method can include parsing the response expression into tokens stored in a response expression tree. The system can determine whether the response expression tree is legal based on a defined grammar structure. Another operation is comparing a numerical evaluation of the response expression to a numerical evaluation of a reference expression. The similarity between the response expression and the reference expression can then be determined by comparing the response expression tree and a reference expression tree. Feedback can be supplied to the student regarding the overall correctness of the response expression as compared to the reference expression, based on correctness of each response expression element and the types of errors among response elements.

### CROSS-REFERENCE TO RELATED APPLICATIONS AND CLAIM OF PRIORITY

This is a US Nationalization of PCT application no. PCT/US2007/002388 filed on Jan. 29, 2007. Priority of U.S. Provisional patent application Ser. No. 60/763,067 filed on Jan. 27, 2006 is claimed.

### FIELD OF THE INVENTION

The present invention relates generally to electronic training and testing.

### BACKGROUND OF THE INVENTION

The United States once produced the highest percentage of bachelor's degrees in the world but now trails behind five other countries including Canada, Japan, and South Korea. Some scholars have suggested that there is the lack of coherence in content and assessment standards between K-12 and higher education, due to a disconnect between what colleges and universities expect from students (preparing students for advanced classes in selected disciplines) and what high schools prepare students for (meeting graduation requirements). A widening gap appears to have developed between the universities' mandate to maintain the highest academic standards and the high schools' commitment to be inclusive under Federal mandates.

As a consequence, the universities do not match their curriculum with that of high schools. This mismatch results in a persistently high proportion of America's high school students who do not have the skills they need to succeed in college. Moreover, fewer students are prepared for college-level science and math courses, as reported by the ACT college admissions tests.

To address this challenge, several programs have offered college-level courses to high school students, including Advanced Placement, Concurrent Enrollment and Early College High Schools. Each program has its strengths and weaknesses. For example, the Advanced Placement program, developed by ACT, offers courses that are designed “to develop mastery of content knowledge, key concepts, and writing skills consistent with college work.” However, beyond the greater demands that are put on high school teachers, many schools set strict prerequisites for AP enrollment that exclude many students. As a result, only a limited percentage of selected students get access to the AP courses that by implication have the opportunity “to gain knowledge of what is required for college success.

The American Education Corporation has put forward another solution for college placement, the A+dvancer™. This is an online courseware is designed for students who did not qualify to college admission, but their scores were very close to the cut-off. The courseware is designed only as a refreshment intervention of general content knowledge skills for students who failed a course placement effort and does not address other weaknesses of less proficient students. Moreover, the program does not allow students to identify and improve their weaknesses by themselves, because it is designed as a diagnostic tool for educators to track students' skills.

ALEKS is another web-based assessment and learning system that is used for college preparation. The program is based on periodic assessments through practice exercises, providing feedback on students' responses in the form of verbal explanations on their current degree of mastery. However, the feedback does not pinpoint the locations nor indicate the specific types of errors in the student's response. Furthermore, the learning process is based on knowledge spaces, rather than on the individual student's error patterns.

Overall, the current tools used for college preparation provide only categories of students' deficiencies, with no identification of their specific errors. Because most colleges and universities have also failed to create a solution to directly articulate their detailed expectations about how students should prepare for college, there is a greater need for both colleges and high schools to provide the tools needed that will increase the educational preparedness of all pre-college students.

### SUMMARY OF THE INVENTION

A system and method are provided of analyzing a mathematical response expression in a freeform format as entered by a student in response to testing and practice questions presented by a computer system. The method can include parsing the response expression into tokens stored in a response expression tree. The system can determine whether the response expression tree is legal based on a defined grammar structure. Another operation is comparing a numerical evaluation of the response expression to a numerical evaluation of a reference expression. The similarity between the response expression and the reference expression can then be determined by comparing the response expression tree and a reference expression tree. Feedback can be supplied to the student regarding the overall correctness of the response expression as compared to the reference expression, based on correctness of each response expression element and the types of errors detected among response elements.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a parser flow diagram in accordance with an embodiment of the present invention;

FIG. 2 illustrates an embodiment of an expression evaluation flowchart;

FIG. 3 is a chart illustrating an embodiment of element analysis for the response expression as compared to the reference expression;

FIG. 4 illustrates a method for transforming an expression tree into a relative canonical form in an embodiment of the invention;

FIG. 5 illustrates an example of sample parser output in an embodiment of the invention;

FIG. 6 illustrates an example scatter-plot of a parser score (x-axis) vs. human score (y-axis) for responses from real-world Pre-Calculus questions;

FIG. 7 illustrates an example of a Multiple Choice question with parser-based continuous scoring in an embodiment of the invention; and

FIG. 8 is a flowchart illustrating an embodiment of a method of analyzing a mathematical response expression in a freeform format as entered by a student in response to mathematical testing questions.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A system and method is provided mathematical expression parser for analyzing students' responses to open-ended mathematical questions. In one embodiment, the parser is a backend process contained within a web accessible or online self-regulated learning and assessment system. The parser's analysis can include three phases: (1) Standard arithmetic and logical rule matching to check whether student's response is a legal expression; (2) Evaluating whether the student's response is correct overall, specifically, mathematically equivalent to the correct answer provided by instructors. The evaluation is based on a fast numerical approach rather than complicated symbolic algebra logic; (3) Error analysis in which the parser classifies each response element as correct, wrong, unrecognized, missing or redundant. Through this analysis, each student receives immediate error feedback on his/her response. The accuracy of this parsing method has been validated against human teacher scoring on real-world examples from an introductory pre-calculus college course. It provides generic automated scoring to different open-ended questions in mathematics, and increases the effectiveness of the learning program.

The present learning program is based on the theory of learning from performance errors and on evidence that error patterns may lead to conceptual misunderstandings and/or lack of proper problem solving strategies. During learning sessions, students are asked to provide free-text responses to each question (the number of responses is not limited). Whenever a response is entered, the parser is invoked to provide the students continuous feedback on their errors. The parser's can then generate a comprehensive error analysis and accurate partial scoring for each response.

The parser has at least two inputs:
Reference Expression: a keyboard-typed string representing the correct answer to the math question. It is provided by instructors and stored in a database.
Response Expression: a keyboard-typed string representing a mathematical expression or equation. It is entered by a student following the presentation of a problem.
   The parser's output is an analysis of the response, and can be divided into three phases:
1. Matching: report whether the response is a legal expression, which adheres to standard arithmetic and logical grammatical syntax rules.
2. Evaluation: report whether the response and reference are mathematically equivalent.
3. Analysis: classify the response's elements into categories using at least one category of correct elements and several categories of erroneous elements.

In prior systems, parsers are widely used for matching purposes only (as in phase 1). Our parser design introduces three additional innovative ideas: (a) controlled-tolerance numerical evaluation for comparing the reference and response, over both real and complex variable values. This approach is simpler, more reliable and more general than computer symbolic algebra systems for the considered educational applications; (b) comparing the response syntax tree relative to the specific reference, rather than reducing both to absolute normal forms and comparing the normal forms; and (c) a sequence of syntax tree transformations (phase 3) that yield meaningful error flagging using an approximate tree matching algorithm. This makes the parser a powerful tool to detect students' errors, and an integrated adaptive learning and assessment system. In one embodiment, the error detection system is implemented in Java, building upon existing open-source parsing libraries.

The parser's algorithm consists of three phases corresponding to the matching, evaluation and analysis steps. We illustrate the three phases on the following example:
Reference: “5x(1−sin(x)̂2)+x̂3”
Response: “8(x/2)̂+(x 5 cos(x) ̂2)”
   Strings in Courier font with quotes will refer to keyboard-typed strings throughout this document.

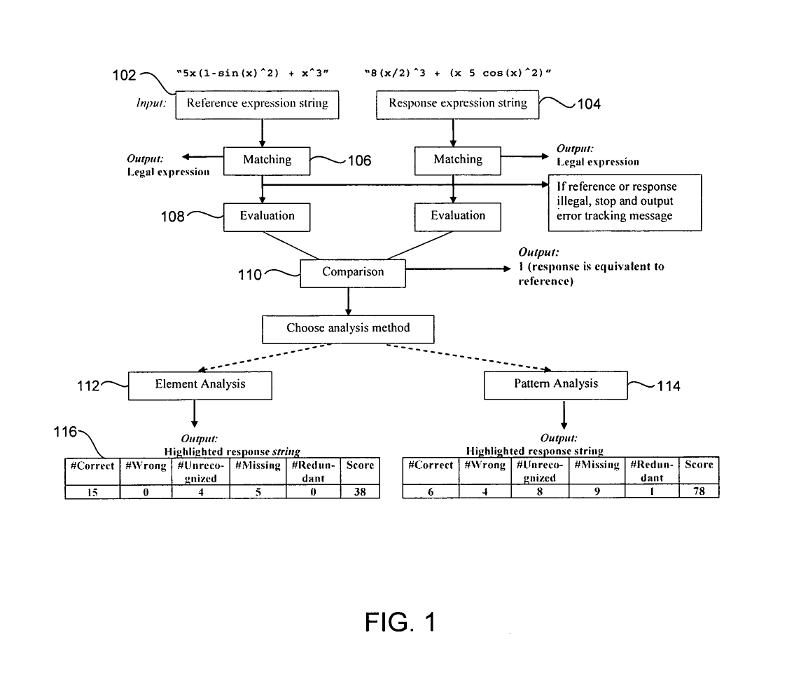

FIG. 1 illustrates an embodiment of a parser flow diagram. Both expressions are matched, numerically compared, and analyzed using two alternative analyses that classify elements into five categories and generate a response total score. Inputs are shown in red and outputs are shown in green.

The matching phase of the process will now be described. Matching 106 determines whether a string belongs to the parser's language, i.e., can be recognized and interpreted. Both the response 104 and reference strings 102 are matched. This parser is of non-deterministic recursive-descent type. Namely, the input string is dissected into tokens, each representing a single mathematical expression element, and matched against grammar rules. “Tokens” and “elements” of a response are interchangeably used hereafter. Each rule corresponds to a simple sub-parser (e.g., a Java method with few code lines) with a corresponding assembler. An expression is considered mathematically legal if and only if each of the invoked sub-parsers finds exactly one match. The grammar rules imply unambiguous matching: a string may have at most one match.

A constructed target object contains the expression's syntax tree and a classification of tokens to numbers, variables, operations and functions. The target is used for the evaluation and analysis phases. For illegal responses or references, evaluation and analysis are skipped and syntax error tracking information is provided on why matching failed. This can help students focus on their conceptual errors rather than on finding typos and syntax errors.

The parser has two main sub-parsers described below: arithmetic, recognizing a single mathematical expression, and logical, recognizing multiple expressions.

The arithmetic grammar includes arithmetic operations, common unary functions (like “sin” or “abs”), common binary functions (e.g. “root (3, 5)” denoting the third root of five), which adhere to conventional arithmetic operator precedence and association. The grammar allows multiple expressions separated by commas, multiple variables (e.g. “x”, “y”, “z”) and multiple constants (π, e, etc.) per response. The parser supports complex, real, rational and integer arithmetic. Although the syntax is slightly more cumbersome for students than an equation editor, it serves two positive purposes: (a) every operation can be highlighted as correct or erroneous in the analysis phase (Section 2.3), e.g. the power operation in “x̂2”. In its textbook form, the expression reads “x²”, where the power operation is invisible and cannot be easily included in a visual error feedback; (b) learning to type the syntax provides students a valuable learning experience in itself. In addition, an equation-editor representation of each text response could be constructed, displaying at least part of the parser analyses.

The grammar rules avoid the problem of left recursion, and their implementation avoids problems with the infinite loop inherent in the cyclic dependencies of the rules. Table 1 shown below illustrates an example of grammar rules that can be used by the arithmetic sub-parser.

TABLE 1
Arithmetic sub-parser grammar rules.

| | |
|---|---|
| expr | = term (plusTerm \| minusTerm)*; |
| plusTerm | = “+” term; |
| minusTerm | = “−” term; |
| term | = factor (timesFactor \| divideFactor \| |
| | modFactor (implicitMultiplication ? |
| | (\| impTimesFactor) : ( )))*; |
| factor | = signOp* part; |
| signOp | = “−” \| “+”; |
| part | = phrase expFactor \| phrase; |
| timesFactor | = ″*″ factor; |
| timesFactor | = ″/″ factor; |
| impTimesFactor | = Empty part; |
| expFactor | = “\hat{ }” factor; |
| phrase | = parenExpr \| funcExpr \| |
| | func2Expr \| argument; |
| parenExpr | = ‘(‘ expr ’)’; |
| funcExpr | = func ‘(‘ expr ’)’; |
| func2Expr | = func2 ‘(‘ expr ’,‘ expr ’)’; |
| func | = “ln” \| “sin” \| “cos” \| . . . \| “+” \| “−”; |
| func2 | = “+” \| “−” \| “*” \| “/” \| \hat{ }” \| |
| | atan2 \| “log” \| “root” \| . . . ; |
| argument | = mathConstant \| variable \| Num; |
| mathConstant | = “pi” \| “e” \| . . . ; |
| variable | = v1 \| . . . \| vN; |

Note that:
implicitMultiplication is an input flag that controls the legality of implicit multiplication. If set, “5x“,“5 x” and “x 5” are all legal and equivalent to “5*x”, but not “x5” that is interpreted as a single variable token; otherwise, only “5*x” is legal. This flag is set by default, and may be unset by the user in applications requiring strict syntax, e.g. programming courses.
v1 | . . . | vN is a list of prescribed variable symbols. They are stored in a database and are question-specific. Normally there are one to three symbols (e.g. ”x”, “y” and “z”). There is no restriction on their number N in matching, but it should be kept small for fast evaluation.
“+” | “−” are recognized as both unary and binary, depending on context.

The logical sub-parser recognizes strings consisting of multiple statements, separated by commas. Every statement is a truth involving variables, constants and operations. Currently a statement is limited to a single relation, which is a pair of expressions delimited by an operation (“=”, “>”, “<”, etc.).

TABLE 2
Logical sub-parser grammar rules.

| | |
|---|---|
| string | = statement (‘,’ statement)*; |
| statement | = singleExpr \| relation; |
| singleExpr | = expr; |
| relation | = expr relop expr; |
| relop | = “=” \| “!=” \| <=” \| “>=” \| “<” \| “>”; |

Using the syntax rules in Tables 1 and 2, both the reference and response examples are reported as legal, and the evaluation and analysis phases are subsequently executed.

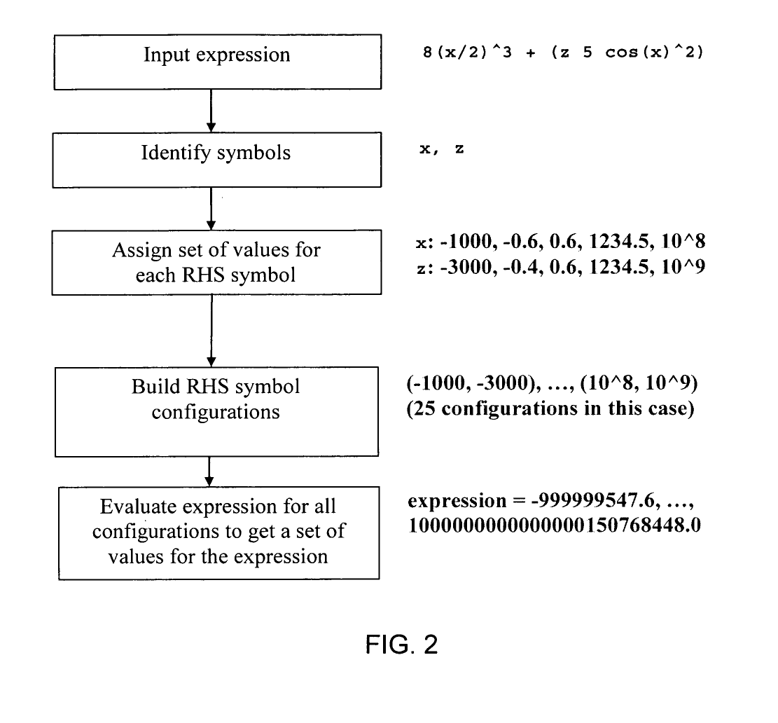

Referring again to FIG. 2, the evaluation phase 108 will now be described. Evaluation decides whether the response and reference are mathematically equivalent. There is no perfect algorithm to determine equivalence, because each mathematical expression can be written in infinitely different ways, some of which are ill-conditioned and others impossible to simplify (for instance, “1−sin (x)̂2” and “cos(x)̂2” are equivalent because of a trigonometric identity). Most software relies on a Computer Algebra System (CAS) to simplify both expressions to a normal form. This means the response and reference are considered equivalent if and only if their normal forms are equal. CAS involves a complicated symbolic code, can be slow, and cannot guarantee perfect detection of mathematical equivalence. Furthermore, some practical questions require the non-simplified answer. E.g., Q: Expand the expression (x+y)̂2; A: “x̂2+2*x*y+ŷ2”. If the student's response is “(x+y)̂2”, CAS will simplify both the reference and response to “(x+y)̂2” and report no errors in the response; our parser will detect the reference-response equivalence during the evaluation phase, but report response errors because the response is not in the required expanded form.

In contrast, the present system and method uses a fast and simple numerical comparison 110 method. For simplicity, suppose first that the reference and response are both single arithmetic expressions (multiple expressions will be discussed later). In each expression, every variable (e.g., “x”) is assigned a few random numerical values (samples). The student response and reference expressions are evaluated for all combinations of samples. They are defined as equivalent if and only if all of their evaluations are equal to within machine precision or a prescribed tolerance.

The samples for each variable have the form s₁*r₁*10^{e1}i*s₂*r₂*10^{e2}, where r_{1,2} is random between 0 and 10, e_{1,2} is integer between −E and E, and s_{1,2}=−1 or 1. We use E=5, which seems to cover the interesting dynamic range for most expressions appearing in mathematics course questions. Identical samples are used for the reference and response. The maximum number of samples per variable is kept below 10, and the total number of symbol variable combinations (the tensor product of the samples sets of all variables) is kept below 1000. As most questions involve at most three variables, the number of combinations is not too large for obtaining a reasonable confidence probability in the result (exponentially decreasing with sample set size).

The criterion for deciding whether two floating-point evaluations x and y of the response and reference, respectively, are equal, is carefully designed:

|x−y|<T*|x|, if |x|,|y|>u,

|x−y|<T, otherwise,

where u is 10 * machine round-off error (u=2*10⁻¹⁵ in our case) and T is a prescribed tolerance (default: T=10⁻¹⁴). The comparison tolerance can be set by the instructor per question.

The advantages of this evaluation strategy are its implementation simplicity, deterministic and relatively short run-time for a reasonable accuracy. CAS comparison depends on the complexity of the expressions' structure, where numerical evaluation does not. Although imperfect, this method was found adequate for numerous expressions appearing in real-world pre-calculus and college algebra questions.

The evaluation supports four arithmetic modes: integer, rational, real and complex (the default mode). In complex mode, the samples are complex-valued, otherwise they are real (of the form is s₁*r₁*10^{e1}). Note that some functions are equivalent over the real line but not over the complex plane (e.g. “abs (x)” vs. “sqrt (x̂2)”). At the end of this stage, the response's and reference's evaluations are rounded according to the arithmetic mode for display. Integer mode rounds the real and imaginary parts to the nearest integer; in rational mode we round each of them (denote it by x) to the fraction of relative distance T to x with the smallest numerator and denominator, using the continued-fraction Hardy-Wright Algorithm. In particular, this reduces fractions like “ 21/12” and “ 42/24” to their normal form “ 7/4”. In real and complex modes, we round the real and imaginary numbers to T decimal digits. FIG. 2 illustrates an embodiment of an expression evaluation flowchart.

An evaluation of responses or input expressions consisting of multiple statements will now be described. Let X, Y, Z, W be arithmetic expressions. Two relations “X op₁ Y” and “Z op₂ W” are said to be equivalent if and only if X=Z, Y=W and op₁=op₂, or X=W, op₁=inv (op₂) and Y=Z, where “=” means the two expressions are equivalent in the sense of the previous section, and inv is the inverse relational operation (e.g., “≦” is inv(“≧”)). “Stand-alone” arithmetic expressions (e.g. “X”) can be incorporated special part of this formalism, with a null operation and right-hand-side (i.e. “X” is assigned the fictitious relation “X null null”), and appropriate equality rules of this special case.

When the response and reference consist of multiple statements (relations), the system computes a binary distance matrix between all response statements and reference statements, whose entries are 1 if the two statements are equal, 0 otherwise. The Munkres assignment algorithm is used to compute the substantially optimal minimum-cost mapping between the two sets of statements. The response and reference are said to be equivalent if and only if a zero cost assignment is found.

The analysis phase of the method is provided to classify the response's elements into five types: correct, wrong (appear at the correct place in the expression's structure but has a wrong value), unrecognized, missing, and redundant. Each type is highlighted in a different text and background color and provides the student with a detailed error feedback. This system and method provides two alternative methods: element analysis and pattern analysis.

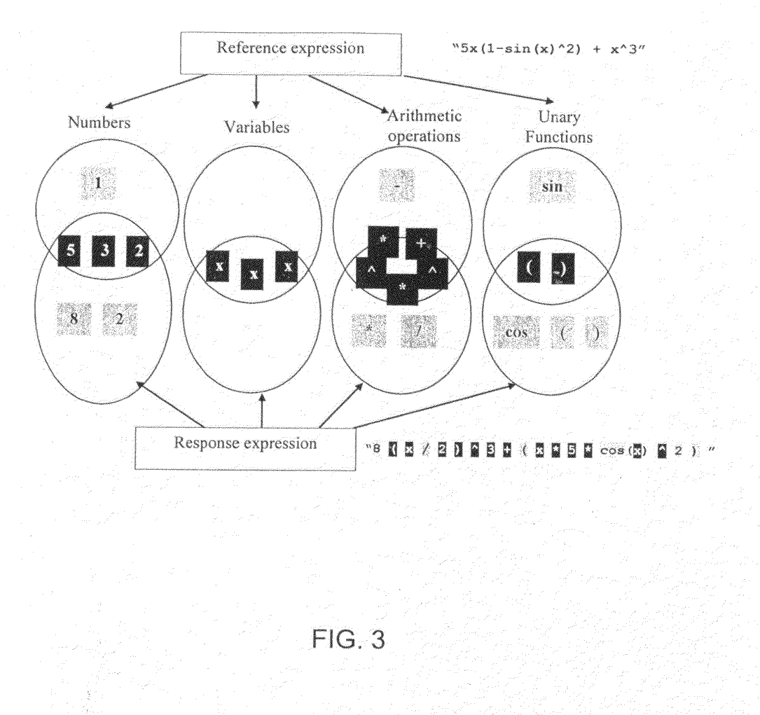

In element analysis 112 (FIG. 1), the syntax tree tokens are binned into separate lists: operations, relational operations, numbers, variables, mathematical constants, unary functions and binary functions. Each list (denoted by R) of the response is intersected with the corresponding reference list (denoted by S). The elements in the intersection R∩S are marked as correct; elements in R\S are marked as unrecognized; elements in S\R are marked as missing. In this analysis there is no distinction between unrecognized and wrong, and there are no redundant elements. This is illustrated in FIG. 3 which depicts the element analysis of the response expression as compared to the reference expression. The implicit multiplications are marked as “*” in the output marked response string.

This analysis was developed first; however it has some significant drawbacks, because it does not take into account the expressions' structure. For instance, one “2” in the example of FIG. 3 is correct and the other one is unrecognized; however they are marked according to their appearance order in the response, and in fact it makes more sense to reverse their labels. The second pair of parentheses should be marked as redundant but is marked as wrong. In other extreme cases, the response as a globally evaluated as incorrect, nevertheless, all its elements are marked correct (e.g.: “3*x+4” VS. “4*x+3”). From the student's perspective, this feedback is ambiguous and confusing.

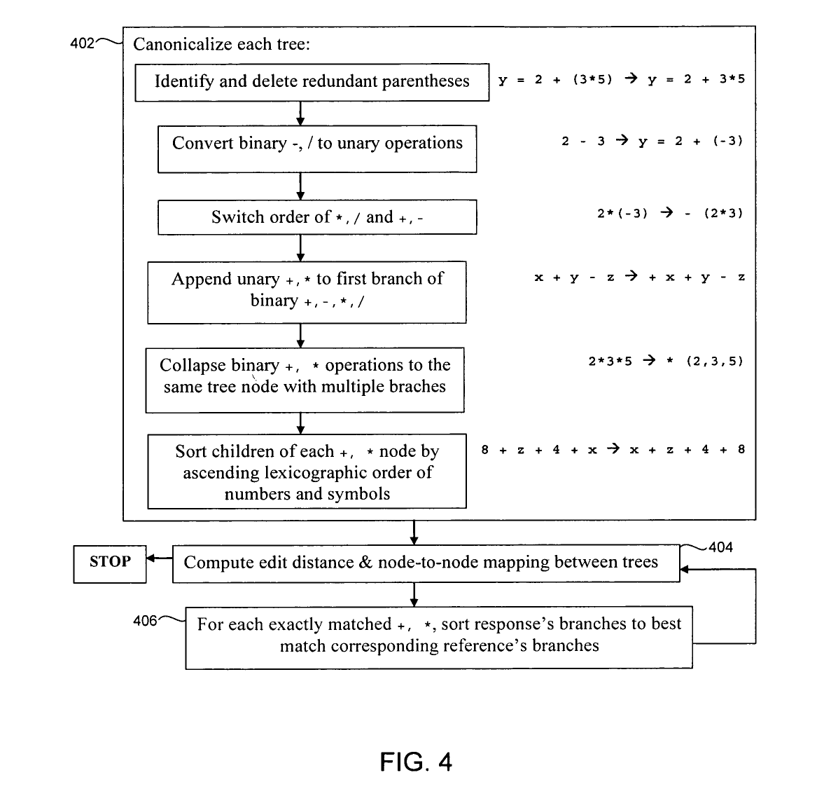

To address the disadvantages of the element analysis, a more powerful analysis by pattern was developed. Pattern analysis 114 (FIG. 2) processes an arithmetic expression in the response and compares the syntax trees of the response and reference. FIG. 4 illustrates that the pattern analysis design consists of three steps: canonicalization 402, edit distance calculation 404, and branch sorting 406. Steps two and three are iterated several times to get an accurate nodal mapping.

First, both expressions are transformed to a canonical form that can be considered a relative canonical form or a non-normalized canonical form. This process consists of six steps that were developed as a result of testing many basic examples (like “2−3” vs. “−3+2” or “2+3+4” vs. “4+2+3”) and assembling a set of rules that result in element classification that give the clearest error feedback all each cases, according to consulted expert cognitive psychologists and educators. For instance, commutative binary operations like “+” are arranged so that their operands (tree branches) are sorted in ascending order (variables, operations and numbers can also embedded into a unified lexicographic ordering). Thus: “5+x+3” is transformed into “x+3+5”. The reference and response tree are separately canonicalized. Redundant parentheses are recognized and removed from the trees at this point.

Second, we compare the resulting trees using Approximate Tree Pattern Matching(ATPM) (Shasha, 1997; Wang, Zhang, Jeong, & Shasha, 1994). The result is the edit distance, which is the minimum number of edit operations (adding a node, deleting a node, replacing a node's value, and replacing the node's place in the tree structure) required to transform the student tree to the correct tree. In our version, nodes are weighted according to their type so the algorithm favors changing an operation and keeping its operands (e.g., “x+y−z” vs. “x−y+z” marks the operations “+” and “−” as wrong and the arguments as correct, rather than marking “+” and “−” as correct and “y”, “z” as wrong). We also construct a nodal mapping that pairs each response tree node with a reference tree node (some nodes may have no counterpart). Response elements classification is then completed:

Exactly matched nodes with identical values are correct elements.

Exactly matched nodes with different values are wrong.

Nodes that appear in the response tree but not in the reference tree are unrecognized.

Nodes that appear in the reference tree but not in the response tree are missing.

In some cases, absolute canonicalization of branches of commutative operations is not desired. Hence, once a correct “+” or “*” is identified, its branches are sorted in the response tree to best match the corresponding reference tree branches ordering. This is done by computing an edit distance between each response and reference branches, and computing the minimum cost Munkres assignment.

The edit distance and mapping can then be recomputed with the updated trees. This process may be repeated a few times to increase the mapping's accuracy, as illustrated in FIG. 4.

The parser's response scoring model consists of two components:
(1) The overall response correctness, represented by a binary value a: a=1 if the response is equivalent to the reference and a=0 otherwise.
(2) Element index, which measures the number of correct elements relative to the total number of elements. Let C be the number of correct elements that are parsed in the student's last response, M be the number of missing elements of the correct solution and let E be the number of errors (number of wrong values plus number of unrecognized elements). Therefore, the response contains C+E elements, and the reference contains C+M elements. Their likeness is thereby measured by their intersection set size (C), relative to their union set size (C+M+E). This index measures the “relative correctness” of the student's response.
   The Parser Scoring Model defines the response score by the convex combination

$$S = θ {\underbrace{* a +}}_{\begin{matrix}Overall \\ correctness\end{matrix}} ( 1 - θ ) * \underbrace{\frac{C}{C + M + E}}_{\begin{matrix}Element \\ index\end{matrix}} , \qquad ( 1 )$$

where 0≦θ≦1 is a weight parameter that was optimized using the validation results. Other scoring schemes are conceivable, for instance, based on the edit distance between the two trees when ATPM is used, which is another global measure of the response's quality. Notwithstanding, the scoring model (1) is a simple and valid formula with respect to human teacher scoring of the same response. It can also be used to compare the two analysis methods, which produce different C, M and E values that in turn lead to different total scores. Our validation studies show that pattern analysis is superior to element analysis, hence employed by default in our algorithm.

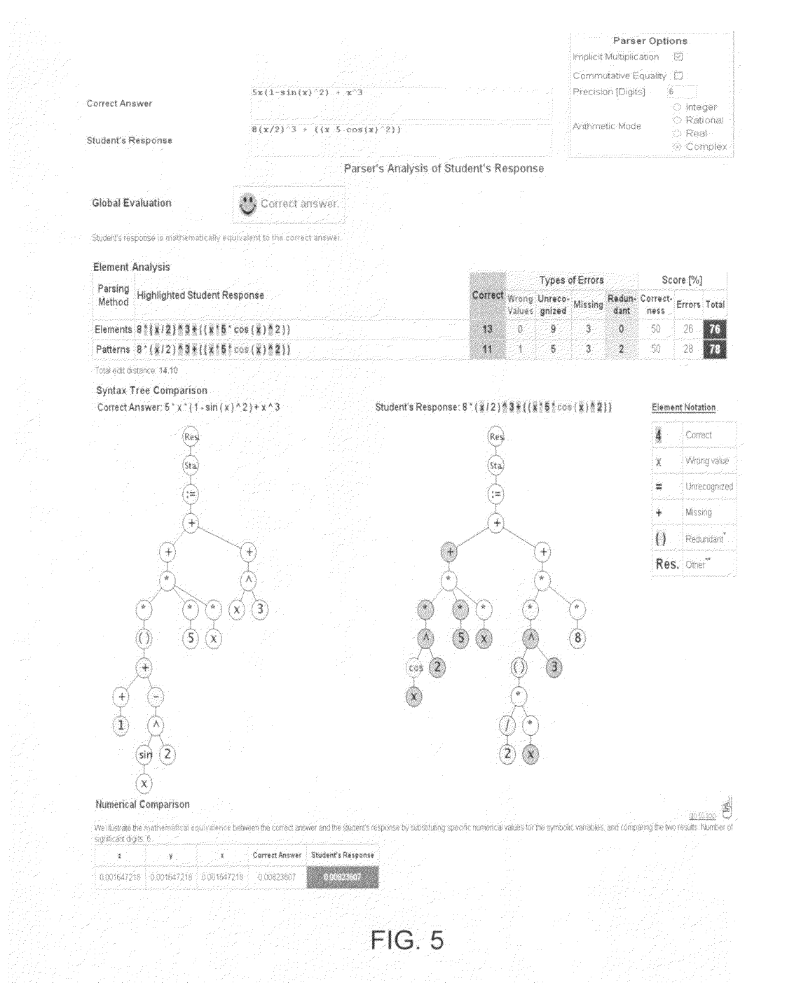

An example of sample parser output will be described below and illustrated in FIG. 5. An interactive parser demo is available online at http://ruready.net/demo. A user can input the instructor reference and student response strings and control the parser options. The result is a detailed analysis demonstrating the algorithm described previously.

To examine the parser scoring model, it was compared against expert human scoring. To this end, three mathematicians independently scored 207 representative real-world responses that were collected from high school students. First, the degree of agreement among the scorers for all the responses was examined by means of Kendall's coefficient of concordance W that is the appropriate measure of agreement among scorers. The results indicated that there was a strong agreement among the scorers on scoring each response (Kendall's coefficient of concordance was W=0.890, p<0.0001), regardless of the questions' level of difficulty. Moreover, the parser score of the same responses matched well with the three human scorers (W=0.886, p<0.0001) and had a strong correlation to each one of them (Pearson r=0.836, p<0.0001).

Based on these results, we investigated how much of the variance of the human scoring could be predicted by the two components parser scoring model (Eq. (1)) using stepwise linear regression. Interestingly, the element index turned out to be the best predictor, predicting 77.3% of the variance. The overall correctness component contributed an additional 5.8%. With both element index and overall correctness weighted with the optimal θ, the parser scoring model explained an impressive 82.5% of the human scoring variance, which is equivalent to a human-parser score correlation of r=0.910, p<0.0001.

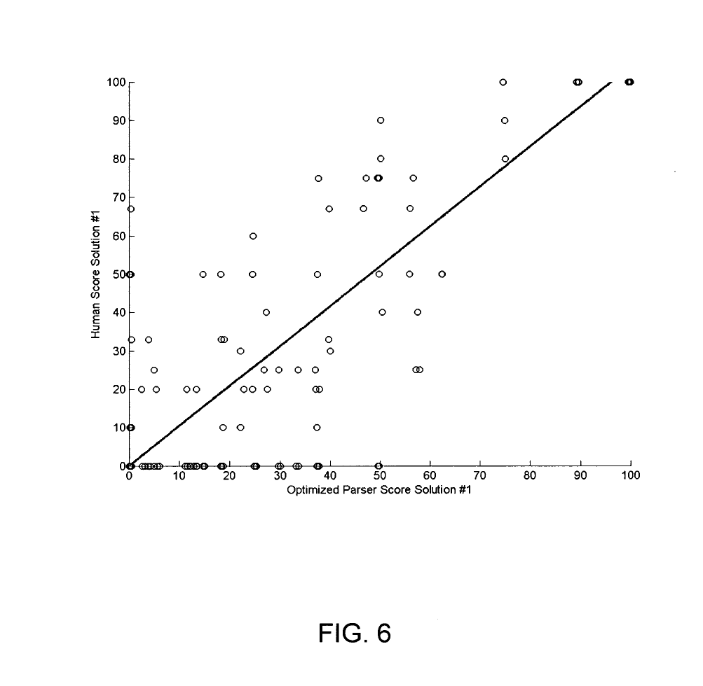

FIG. 6 illustrates a scatter-plot of the parser score (x-axis) vs. human score (y-axis) for 207 responses from real-world Pre-Calculus questions. The red regression line has a slope of 1.03 (i.e., a human score of a 100 is approximately equivalent to a parser score of 97).

In addition to its stand-alone capabilities, the parser has been used at the core of a college readiness learning and assessment Web site, representing an exemplar to educational applications.

A vital challenge in online learning systems is the design of a general algorithm to assess different mathematical questions. As was demonstrated, the parser's scoring formula is robust enough to uniformly be used to score a large set of sample questions. The current parser provides a general scoring rubric for responses to different open-ended questions in mathematics. It replaces current content-dependent rubrics, which required complicated development per specific questions.

The present system and method can also provide partial scoring for Multiple-Choice (MC) questions. Each distractor (choice) may be regarded as a potential response to the corresponding open-ended question, analyzed and assigned a score by the parser. A teacher can use the error highlights to design distractors corresponding to common student misconceptions. Given that MC questions are currently invariably scored as correct/incorrect, our parser-based continuous scale provides an improvement to the current multiple-choice testing framework.

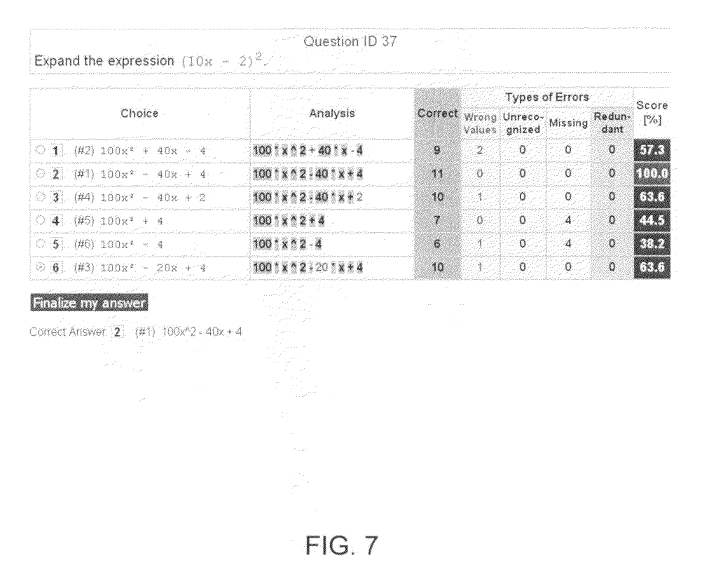

FIG. 7 illustrates an example of an MC question with parser-based continuous scoring. Traditionally, choice 2 would receive a 100 and all other choices would receive a 0. The parser enables partial scoring for each distractor included in the question.

The present system and method provide individualized learning through error feedback. The parser robustness empowers the development of online individualized learning programs. Through immediate feedback by highlighting conceptual and computational errors for responses to practice questions, each student is prompted to eliminate the number and severity of response errors to reach the final answers at his/her own pace, This ongoing error-based feedback ensures that students focus on resolving their own misconceptions and negative patterns, thereby developing better mathematics understanding rather than memorizing specific knowledge. Moreover, the automated error analysis can also be used to designing error-based instructional units matched to content deficiencies for each individual student.

The parser scoring can also be used in assessment tests to measure the current level of student readiness to take the college course under consideration. In case the student is not yet ready, the next practice sessions are adapted to the parser-based assessment test scores on each topic, so that more questions are shown on the individual student's areas of weakness. The error-based adaptation allows the student to learn about the erroneous sources of his misconceptions, rather than only indicating what he/she knows and what they does not know. Here the parser's accuracy in detecting errors boosts the efficiency of the adaptive remediation process.

The present system and method can also be used to assist with scoring of parametric questions. Each question in the database contains several parameters (e.g. a and b) that assume random values each time the question is displayed to a student. The parser allows building complex templates that include parametric expressions enclosed by “#”# signs. For instance, Q: Expand the expression (#a#*x+#b#*y)̂2; A: “#â2#*x̂2+#2*a*b#*x*y+#b′2#*ŷ2”. The parametric expressions are evaluated before any student response is entered, using the parser with the specific values of a and b. Each expression may include control sequences to specify the evaluation mode, e.g. rational or real arithmetic modes, and comparison tolerances.

Parametric questions are a powerful educational tool that has already been in use, because they prevent student memorization of specific answers and student copying. However, the current parser largely increases the parametric prompt's scope, as it allows arbitrary parametric expressions containing arbitrarily many parameters and parameter ranges. Even with two parameters, each assuming one of 100 possible values, there are already 10,000 different question instances of one parametric question. Yet, the scoring formula (I) is uniformly used for all combinations of parameter values.

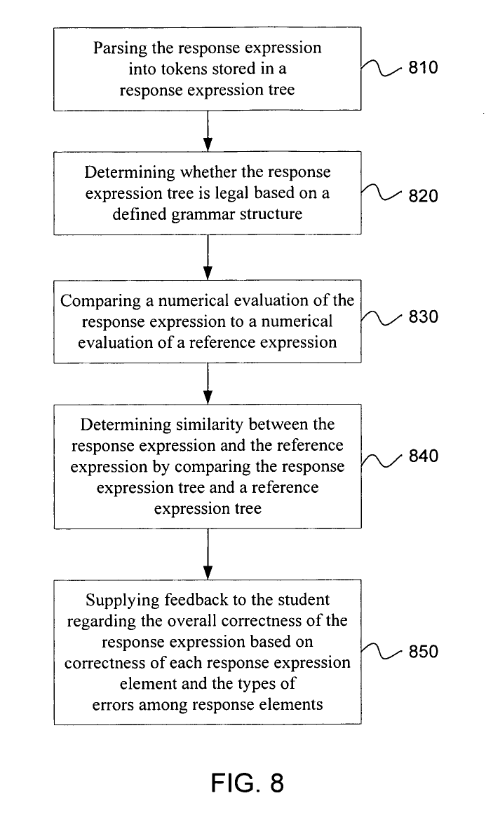

FIG. 8 is a flowchart illustrating an embodiment of a method of analyzing a mathematical response expression in a freeform format as entered by a student in response to mathematical testing questions. The method can analyze a response expression in a freeform format. The response expression is entered into a text box by a student in response to testing questions presented by a computer system. The processes that analyze the expression may be located on a web server and a web application can send the response expression to the web server. Alternatively, the analysis process and the supporting educational system may be located in a stand alone executable program that is located on a local machine where the student is located.

The method can begin by parsing the response expression into tokens stored in a response expression tree, as in block 810. Then the response expression tree is checked to determine whether the tokens as contained within the response expression are legal based on the defined grammar structure, as in block 820. The grammar can be the grammar as defined within this document or some other grammar that defines mathematical expressions.

The method then compares a numerical evaluation of the response expression to a numerical evaluation of a reference expression, as in block 830. The evaluation is done by evaluating each expression with a selected number of values. If the response expression and the reference expression are numerically the same, then each expression should produce the same final value.

Once the parsing and numerical evaluation are complete, the expressions are analyzed in further detail. Specifically, the system can determining the similarity between the response expression and the reference expression by comparing the response expression tree and a reference expression tree, as in block 840. The similarity can be determined in two ways. In one method, element analysis is applied to compare the response expression with the reference expression to find an intersection of elements and identify correct elements and to identify missing elements outside of the intersection.

In another method, the similarity can be determined by comparing the response expression tree and the reference expression tree using approximate tree pattern matching. The approximate tree pattern matching can be determined by tracking the number of edit operations used to transform the response expression tree to a nearest approximation of the reference expression tree, as described previously.

Then feedback can be supplied to the student regarding the overall correctness of the response expression as compared to the reference expression, as in block 850. The overall correctness is judged based on the correctness of each response expression element and the types of errors among response elements.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of analyzing a response expression in a freeform format as entered by a student in response to mathematical testing questions presented by a computer system, comprising the steps of:
parsing the response expression into tokens stored in a response expression tree;
determining whether the response expression tree is legal based on a defined grammar structure;
comparing a numerical evaluation of the response expression to a numerical evaluation of a reference expression;
determining similarity between the response expression and the reference expression by comparing the response expression tree and a reference expression tree; and
supplying feedback to the student regarding overall correctness of the response expression as compared to the reference expression, based on correctness of each response expression element and types of errors detected among response elements.

2. A method of claim 1, wherein the step of determining similarity between the response expression and the reference expression, further comprises the step of applying element analysis to compare the response expression with the reference expression by finding an intersection of elements between the response expression and the reference expression to identify correct elements and to identify missing elements outside of the intersection.

3. A method of claim 1, wherein the step of determining similarity further comprises the step of comparing the response expression tree and the reference expression tree using approximate tree pattern matching.

4. A method of claim 3, wherein the step of determining similarity between the response expression and the reference expression further comprises the step of transforming the response expression and the reference expression into a defined relative canonical form.

5. A method of claim 4, wherein the step of comparing the response expression tree and reference expression tree using approximate tree pattern matching further comprises the step of calculating an edit distance between the response expression tree and the reference expression tree by tracking a number of edit operations used to transform the response expression tree to a nearest approximation of the reference expression tree.

6. A method of claim 5, wherein the edit operations are selected from the group consisting of: adding a node, deleting a node, replacing a node's value, and changing a node's location in the response expression tree.

7. A method as in claim 4, further comprising the step of constructing a nodal mapping to pair each response expression tree node with a reference expression tree node.

8. A method as in claim 7, further comprising the step of weighting nodes according to type with respect to edit operations.

9. A method of claim 1, wherein the step of determining whether the expression is legal further comprises the step of defining the grammar structure as a mathematical grammar structure.

10. A method of claim 2, wherein the step of determining whether the response expression is legal further comprises the step of parsing the response expression by using a Boolean-logic sub-parser and then a mathematical logic sub-parser.

11. A method of claim 1, further comprising the step of presenting a student with a mathematical problem for which the student is asked to enter the response expression.

12. A method of claim 11, wherein the reference expression is provided by an instructor in non-normalized form as an answer to the mathematical problem presented to the student.

13. A method of analyzing a response expression in a freeform format as entered by a student in response to mathematical testing questions presented by a computer system, comprising the steps of:
parsing the response expression into tokens that are stored in a response expression tree;
determining whether the response expression tree is legal based on a defined grammar structure;
comparing a numerical evaluation of the response expression to a numerical evaluation of a reference expression;
determining similarity between the response expression and the reference expression by comparing the response expression tree and a reference expression tree using approximate tree pattern matching; and
supplying feedback to the student regarding the overall correctness of the response expression as compared to the reference expression, based on correctness of each response expression element, and types of errors detected among response elements.

14. A method of claim 13, wherein the step of determining similarity between the response expression and the reference expression further comprises the step of transforming the response expression and reference expression into a defined relative canonical form.

15. A method of claim 14, wherein the step of comparing the response expression tree and reference expression tree using approximate pattern matching further comprises the step of calculating an edit distance between the response expression tree and the reference expression tree by tracking a number of edit operations used to transform the response expression tree to a nearest approximation of the reference expression tree.

16. A method of claim 15, wherein the edit operations are selected from the group consisting of: adding a node, deleting a node, replacing a node's value, and replacing a node's place in the response expression tree.

17. A method as in claim 16, further comprising the step of weighting nodes in the response expression tree according to their type with respect to the edit operations.

18. A method as in claim 17, further comprising the step of constructing a nodal mapping to pair each response tree node with a reference tree node.

19. A method as in claim 18, further comprising the step of sorting a response expression's branches to match as closely as possible a reference expression's branches.

20. A method as in claim 14, wherein the step of transforming the response expression and the reference expression into a defined relative canonical form further comprises the steps of:
deleting redundant parentheses from expressions;
converting binary to unary operations in the expressions;
switching an order of multiplication and division operations with unary operations;
appending the unary operations to a first branch of binary +, −, *, and / operations;
collapsing binary +, / operations to a same tree node with multiple branches;
sorting children of each +,* node in ascending lexicographic order; and
applying an optimal matching algorithm to match reference and response statement branches.

21. A method of analyzing a response expression in a freeform format as entered by a student in response to mathematical testing questions presented by a computer system, comprising the steps of:
parsing the response expression into tokens that are stored in a response expression tree;
determining whether the response expression tree is legal based on a defined grammar structure;
comparing a numerical evaluation of the response expression to a numerical evaluation of a reference expression;
transforming the response expression and the reference expression into a defined canonical form;
tracking a number of edit operations used to transform the response expression tree to a nearest approximation of the reference expression;
sorting the response expression to a nearest match to the reference expression; and
supplying feedback to the student regarding overall correctness of the response expression as compared to the reference expression, based on correctness of each response expression element, and types of errors detected among response elements.

22. A method as in claim 21, further comprising the step of determining similarity between the response expression and the reference expression by calculating a number of edit operations and sorting operations performed to transform the response expression to a state as similar to the reference expression as possible.

23. A method as in claim 21, further comprising the step of sorting the response expression for each + and / to match the reference expression as closely as possible to the response expression.

24. A method as in claim 21, further comprising the step of enabling a student to view the feedback and enter a modified response expression.

25. A method as in claim 21, wherein the step of supplying feedback to the student further comprises the step of marking correct elements in green and erroneous elements in yellow background and using a plurality of text colors signifying the types of errors.
